(19) United States
(12) Patent Application Publication
(10) Pub. No.: US 2009/0081796 A1
(43) Pub. Date: Mar. 26, 2009

(54) METHOD FOR THE DETERMINATION OF PHOSPHOLIPIDS IN AMNIOTIC FLUID SAMPLES

(75) Inventors: Maria Irene De Oliveira Monteiro Jesus Rebelo, Porto (PT); Belmiro Dos Santos Patricio, Porto (PT)

Correspondence Address: SUGHRUE MION, PLLC, 2100 PENNSYLVANIA AVENUE, N.W., SUITE 800, WASHINGTON, DC, 20037, US

(73) Assignee: UNIVERSIDADE DO PORTO, Porto (PT)

(21) Appl. No.: 12/159,768

(22) PCT Filed: Jul. 31, 2007
(86) PCT No.: PCT/IB07/53011

§ 371 Date: Jun. 30, 2008

(30) Foreign Application Priority Data
Jul. 31, 2006 (PT) 103547

(51) Int. Cl. G01N 30/94

(52) U.S. Cl. 436/71

(57) ABSTRACT

The present invention refers to a fast method for the determination of phospholipids in amniotic fluid samples by HPTLC (high performance thin layer chromatography). This innovative method presents high sensitivity, reproducibility and resolution. It has also the advantage of being of easy laboratorial interpretation, allowing the elimination of false results due to the contamination of the sample with blood or meconium.

### TECHNICAL DOMAIN OF THE INVENTION

The present invention refers to a method of determination of phospholipids in amniotic fluid samples by high performance thin layer chromatographic techniques (HPTLC). It has application in the pharmaceutical industry (development of kits of diagnosis) in the respiratory deficiency in hyaline membrane disease of newborns.

### SUMMARY OF THE INVENTION

The aim of the present invention supplies a method for the determination of phospholipids in amniotic fluid samples through the use of techniques of high performance thin layer chromatography (HPTLC, applied to samples of amniotic liquid, allowing the determination of the foetal lung maturity, in this way, presenting as advantage its great easiness of execution and economy).

Extraction of phospholipids contained in the sample is performed by share of organic solvent (chloroform, methanol) in adequate proportions to the extraction of ten-sioactive compounds to analyse. Its separation is performed by a mixture of solvent (chloroform, methanol, ammonium and water) with the suitable polarity to a good resolution of the constituents of the sample. Plaque revelation to the interpretation of the results is performed with a universal developer (iodine vapour). This method, whose execution takes about 90 minutes, besides allowing to separate and to identify phospholipids, still has the capacity to eliminate the occurrence of false negatives and false positives.

### BACKGROUND OF THE INVENTION

Neonatal respiratory distress syndrome by hyaline membrane disease is the main cause of newborn death, the reason why foetal lung maturity is of great importance. This syndrome, originated for deficient production of surfactant production by the lung in the neonatal period may be evaluated through analysis in amniotic fluid. Lipids present in amniotic fluid have been used as indicators of foetal lung maturity, namely the ratio phosphatidylcholine/sphingomyelin ratio (L/S) higher than 2, but the presence of phosphatidylglycerol, however, seems to constitute a more appropriate indicator of lung maturity.

Nowadays, the determination of foetal lung maturity is performed by the identification of phosphatidylglycerol in amniotic fluid.

The previous methods were based on:
a) the evaluation of the surfactant/albumin ratio—described as a fast and reliable method in diabetics, it has as main inconvenience the necessity of acquisition of specialized equipment (Russell J C: AN1988-015651);
b) the evaluation of L/S ratio with detection of phosphatidylglycerol—one is about a difficult technique, taking a long time, that moreover uses reagents not very usual in the analytical laboratory (Rosenthal M A: AN-1987-207622);
c) the evaluation of phosphatidylglycerol (amnioStat-FLM)—a fast technique, reliable in diabetics but with a high incidence of false negative results;
d) the evaluation of tensioactivity (stability foam test)—one is about a fast method, but that does not eliminate the interference due to possible contamination of the sample with blood and/or meconium (Clements J A, Platzer A G, Tierney D F, Hobel C J, Creasy R K, Margolis A J, et al. Assessment of the risk of respiratory distress by a rapid test for surfactant in amniotic fluid. NEMJ 1972). This method of determination of foetal lung maturity through the identification of phosphatidylglycerol in amniotic fluid is faster and uses reagents of more common use than the technique related in b).

In comparison with the ‘amnioStat-FLM’ technique, where it is referred an elevated number of false negatives, in the present method this interference is eliminated.

Concerning tensioactivity, determined by the method related in d), this determination does not allow eliminate the interferences due to the contamination with blood or meconium, in contrast of that it happens in the proposed method, where none of these contaminants interferes in the analysis.

In summary, this method allows eliminate the false results (positive or negative), it uses common reagents and it has the advantage of the result still not be affected by the contamination of the sample with blood or meconium.

The technique previously developed in our laboratory takes more time (takes about 120 minutes), needs the acquisition of appropriate material (colunes Extrelut 3), what takes more time and the chromatographic development, although of being performed in the same kind of chromatographic plaque, uses a different mixture of eluents, expressing less sensitivity of the technique (100 times). This method allows only the detection of concentrations of standard around 1 microgram/microlitre, whereas the new one detects concentrations of standard around 0.01 microgram/microlitre. [AE1] The revelation process, aided by sulphuric acid, followed by heating at 125° C., increases in 20 minutes the time of the analysis.

In the FIGURE it can be observed the results obtained for a serie of standards in the cited conditions: sphingomyelin (S); phosphatidycholine (PC); phosphatidylglycerol (PG) analyzed individually or in mixture (x) and still of two samples of amniotic fluid. It is possible to identify the presence of phosphatidylglycerol in the amniotic fluid. Still in this plate in a semiquantitative analysis of the different spots was performed and in the samples where was evident the presence of phosphatidylglycerol, the phosphatidycholine/sphingomyelin was higher than 2.

### GENERAL DESCRIPTION OF THE INVENTION

The aim of the present invention supplies a method for the determination of phospholipids in samples of amniotic liquid. For this effect, a sample of the amniotic fluid is collected for analysis.

After that, it is proceeded the extraction from phospholipids contained in the sample with resource to the share of solvent organic (chloroform and methanol) in adequate ratios to the extraction of the tensioactives to be analyzed. Its separation is effectuated by mixture of solvent (chloroform, methanol, ammonium and water) with the suitable polarity to a good resolution of the constituents of the sample.

The samples treated to this form are then applied to the high resolution plates of high performed thin layer chromatography (HPTLC), and its revelation performed, in a reversible way, with a universal developer (iodine vapour).

This method, whose execution delays about 90 minutes, besides allowing to separate and to identify phospholipids, has still the capacity to eliminate the occurrence of false negatives and false positives results.

### DETAILED DESCRIPTION OF THE INVENTION

The obtained samples of amniotic fluid, by transabdominal amniocentese, are centrifugated at low speed (180 g) to eliminate the presence of cells of descamation, erythrocytes and/or meconium, in order to prevent possible contaminations of the sample for the occurrence of false results.

After that, for the purpose of separation of the phospholipids, they are submitted to a process of extraction with solvent organic with different polarities, as for example a mixture of chloroform/methanol (2:1) adding in a first phase the solvent with the highest polarity, after which the solvent with the lowest polarity is successively added.

The chloroform phase is evaporated to dryness, through the application of an inert gas stream (nitrogen), at room temperature to prevent the oxidation of phospholipids contained in the sample and, after that, is treated with cold acetone (−4° C.) to precipitate tensioactive phospholipids.

The obtained precipitate, dissolved in the lowest polarity solvent, is then applied on the HPTLC plate of chromatography simultaneously with the standards of phosphatidylcholine, sphingomyelin, phosphatidylglycerol and phosphatidylinositol.

After that the plate is developed in an appropriate solvent (e.g.: a mixture of chloroform/methanol/ammonium/water) (2:1; 1:3).

The revelation is carried in chamber saturated with iodine vapour, and plate reading performed by comparison with standards: phosphatidylcholine, sphingomyelin, phosphatidylglycerol and phosphatidylinositol.

Face to the methods contained in the state of the technique this invention presents the following advantages:
to allow the reduction of the analysis time (about 90 minutes);
to present high precision and reproducibility;
to eliminate false positives and false negatives, over all due to not interference of meconium or blood (possible contaminants of the sample);
to be a technique of low cost; therefore only uses common reagents in all laboratory analysis.

### DESCRIPTION OF THE DRAWINGS

FIG. 1 presents an image of a HPTLC plate after being revealed with iodine during 5 min. S (sphingomyelin); PC (phosphatidylcholine); PG (phosphatidylglycerol); X (mixture of standards: S+PC+PG); LA (amniotic fluid).

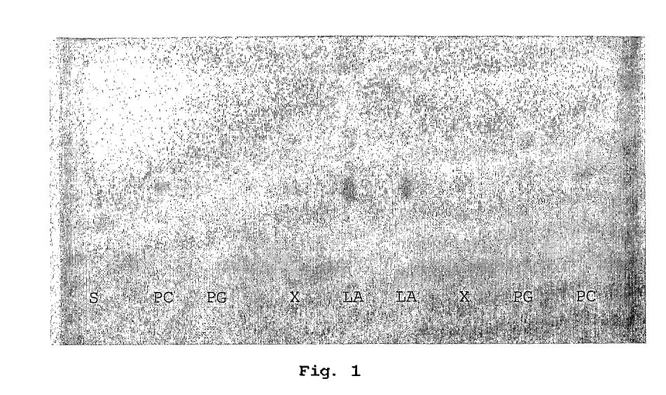

### EXAMPLES OF APPLICATION

I—In a preferred accomplishment of the present invention, samples of amniotic fluid obtained by transabdominal amniocentesis are:
1. centrifugated (140 g during 10 minutes);
2. 1 ml of the supernatant is transferred to a polyethylene centrifuge tube, and 1 ml of methanol added;
3. vortexed during 15 seconds;
4. 1 ml of chloroform is added, vortexed during 15 seconds;
5. centrifugated (1000 g during 5 minutes);
6. the inferior phase obtained after centrifugation is transferred to another tube (tube 2);
7. 1 ml of chloroform is added, vortexed during 15 seconds;
8. centrifugated (1000 g during 5 minutes);
9. the inferior phase obtained after centrifugation is transferred to another tube;
10. 1 ml of chloroform is added, vortexed during 15 seconds;
11. centrifugated (1000 g during 5 minutes);
12. to transfer the inferior phase, obtained after centrifugation to tube 2;
13. to evaporate chloroform phase to dryness in water bath with nitrogen;
14. to cool the tube of operation 13 in ice during 10 minutes;
15. to add XX drops of acetone (cooled about 4° C.);
16. keeping at −20° during 20 minutes;
17. to decant and to dry the residue in nitrogen;
18. to dissolve the residue in 1 ml chloroform, apply in the HPTLC plate with a microapplicator at 0.5 cm of edge;
19. apply simultaneously standards of phosphatidylcholine, sphingomyelin, phosphatidylglycerol and phosphatidylinositol;
20. develop the plate in horizontal chamber, previously saturated with developing (chloroform/methanol/ammonium/water) (10:5:0.3:0.5) in 6.5 cm distance;
21. evaporate the developing eluent with the aid of a hair drier;
22. reveal the plate in an iodine chamber;
23. interpretation of the results by comparison with the related standards.

1. Method for the determination of phospholipids in samples of amniotic liquid characterized for understanding the following steps:
centrifugation of amniotic fluid sample;
separation of the phospholipids from the supernatant with resource to sequential extraction with organic solvents, with agitation;
addition of other solvent organic of lower polarity followed by agitation;
centrifugation;
to the inferior phase add the solvent of lowest polarity and agitate;
3 repetitions of the previous step;
drying of the resultant samples of the extraction with the solvent of lowest polarity, by evaporation in nitrogen stream;
cooling the sample in ice during about 10 minutes;
addition of cooled acetone to the sample;
maintenance of the sample at −20° C. during about 20 minutes;
to precipitate the sample, and to dry the residue in nitrogen stream;
to dissolve the residue in the less polar solvent (chloroform);
to apply the sample in a high performance thin layer chromatographic plate (HPTLC);
to apply in the plate, of analogous form, the standards phosphatidylcholine, sphingomyelin, phosphatidyglycerol, phosphatidyinositol;
elution of the plate in appropriate eluent (e.g. chloroform/methanol/ammonium/water);
to allow the evaporation of the developing solvent;
revelation in chamber saturated with iodine.

2. The method for the determination of phospholipids in samples of amniotic fluid, in accordance with claim 1, characterized by the centrifugation of samples of amniotic fluid at low speed (180 g) to eliminate the presence of cells of descamation, erythrocytes and/or meconium.

3. The method for the determination of phospholipids in samples of amniotic fluid in accordance with claim 1, characterized by the use, in the separation of the phospholipids, of an organic solvent or a mixture of organic solvents.

4. The method for the determination of phospholipids in samples of amniotic fluid in accordance with claim 3, is characterized by the use in the separation of the phospholipids a mixture of chloroform/methanol (2:1).

5. The method for the determination of phospholipids in samples of amniotic fluid in accordance with claim 4, characterized by the use in the separation of the phospholipids of a mixture of chloroform/methanol (2:1) adding in a first phase the solvent of higher polarity and after that of lowest polarity.

6. The method for the determination of phospholipids in samples of amniotic fluid, in accordance with claim 1, characterized by drying the phospholipids with resource to an inert gas stream, such as nitrogen, at ambient temperature in order to prevent the oxidation of the phospholipids.

7. The method for the determination of phospholipids in samples of amniotic fluid, in accordance with claim 1, characterized for precipitating tensioactive phospholipids with resource to addition of cooled acetone at about 4° C.

8. The method for the determination of phospholipids in samples of amniotic fluid, in accordance with claim 1, characterized by dissolving the obtained precipitated with resource to the solvent addition of lowest polarity, such as chloroform.

9. The method for the determination of phospholipids in samples of amniotic fluid, in accordance with claim 1, characterized by the application of the standards in HPTLC plate, mentioned in claim 1, and the residue obtained after extraction of the sample in the already described conditions in the previous claims.

10. The method for the determination of phospholipids in samples of amniotic fluid, in accordance with claim 1, characterized for carrying the elution of the plate in a HPTLC chamber, using an appropriate eluent, as for instance a mixture of chloroform/methanol/ammonium/water (2:1; 1:3) for the separation of different phospholipids present in amniotic fluid.

11. The method for the determination of phospholipids in samples of amniotic fluid, in accordance with claim 1, characterized for carrying the revelation in chamber saturated with iodine vapour in order to allow the visualization of phospholipids.
